(19) United States
(12) Patent Application Publication
(10) Pub. No.: US 2003/0154485 A1
(43) Pub. Date: Aug. 14, 2003

(54) Allocation of recording space per user and application

(76) Inventors: Carolynn Rae Johnson, Indianapolis, IN (US); Phillip Aaron Junkersfeld, Fishers, IN (US); Daniel Richard Schneidewend, Fishers, IN (US)

Correspondence Address: JOSEPH S. TRIPOLI, THOMSON MULTIMEDIA LICENSING INC., 2 INDEPENDENCE WAY, P. O. BOX 5312, PRINCETON, NJ, 08543-5312, US

(21) Appl. No.: 10/121,403

(22) Filed: Apr. 12, 2002

Related U.S. Application Data
(60) Provisional application No. 60/356,435, filed on Feb. 12, 2002.

(51) Int. Cl. H04N 9/74; H04N 9/79; H04N 9/87; G11B 27/00; G06F 3/00; H04N 5/445; H04N 5/91; H04N 7/00; G06F 13/00; H04N 7/173; H04N 7/16

(52) U.S. Cl. 725/89; 725/134; 725/142; 386/46; 386/4; 386/35

(57) ABSTRACT

A system and method for partitioning storage space in a video recording system or multi-media system into a plurality of discrete partitions. Each of the discrete partitions can be allocated to a different user of the video recording system or application of the multi-media system. Furthermore, the systems are designed to allocate an amount of the storage space to each partition to eliminate hoarding of the storage space by only one user or application.

### CROSS REFERENCE TO RELATED APPLICATIONS

This application claims priority and benefit from the U.S. Provisional Patent Application Serial No. 60/356,435 filed on Feb. 12, 2002.

### FIELD OF THE INVENTION

The present invention relates to video recording systems and, more particularly, to a video recording system that allows a user to partition the storage space available in the system's storage medium and allocate each partition of storage space to a different respective user.

The present invention also relates to multi-media systems and, more particularly, to a multi-media system that partitions the memory by application wherein some applications may be further partitioned (subpartitioned) for different users.

### BACKGROUND OF THE INVENTION

Personal video recording systems (PVRs) and digital video recording systems (DVRs) allow a user to record programming to memory such as, for example, a hard disk drive. The amount of programming that can be stored depends on, among other things, 1) the size of the hard disk drive, and 2) the quality of the recordings made. Conflicts can occur when one member of a multi-person household reserves large amounts of this storage space by recording programming or scheduling timers to record future programming, leaving insufficient space available for other members of the household to record or schedule recording of programming.

### SUMMARY OF THE INVENTION

The present inventors recognize that such conflicts can become more problematic in households with multiple teenage children. In addition, the above conflict would also occur with multi-media systems, especially, when more than one multi-media applications may be sharing the same memory recoding space.

Accordingly, the present invention contemplates a multi-media system that partitions the memory or storage space into dedicated application partitions for each application and allows at least part one application partition to be subdivided into subpartitions, each subpartition adapted to be allocated to a respective user.

Furthermore, the present invention contemplates a system with a procedure using on-screen user interfaces that would allow at least part of the recording storage space of a PVR or DVR to be partitioned or divided into discrete partitions of storage space, each partition allocated or authorized for use by a respective user or a type of application. The amount of the storage space in each discrete partition is controlled by an administrator or user.

### BRIEF DESCRIPTION OF THE DRAWINGS

FIG. 1 illustrates a setup on-screen user interface for use in carrying out the method in accordance with the present invention.

FIG. 2 illustrates a partitioning on-screen user interface for use in carrying out the method in accordance with the present invention.

FIG. 3 illustrates a partition naming on-screen user interface for use in carrying out the method in accordance with the present invention.

FIG. 4 illustrates a partition sizing on-screen user interface for use in carrying out the method in accordance with the present invention.

FIG. 5 illustrates a partition protection on-screen user interface for use in carrying out the method in accordance with the present invention.

FIG. 6 illustrates a partition sharing on-screen user interface for use in carrying out the method in accordance with the present invention.

FIG. 7 illustrates an electronic programming guide with an overlaid menu identifying the discrete partitions.

FIG. 8 depicts a general block diagram of the space partitioning system of the present invention.

FIG. 9 illustrates a general block diagram of the multi-media entertainment system in accordance with the present invention.

FIG. 10 illustrates a partition (memory) management on-screen user interface for use in carrying out the method in accordance with the present invention.

FIG. 11 illustrates an alternate embodiment of a partition (memory) management on-screen user interface for use in carrying out the method in accordance with the present invention.

### DETAILED DESCRIPTION OF THE INVENTION

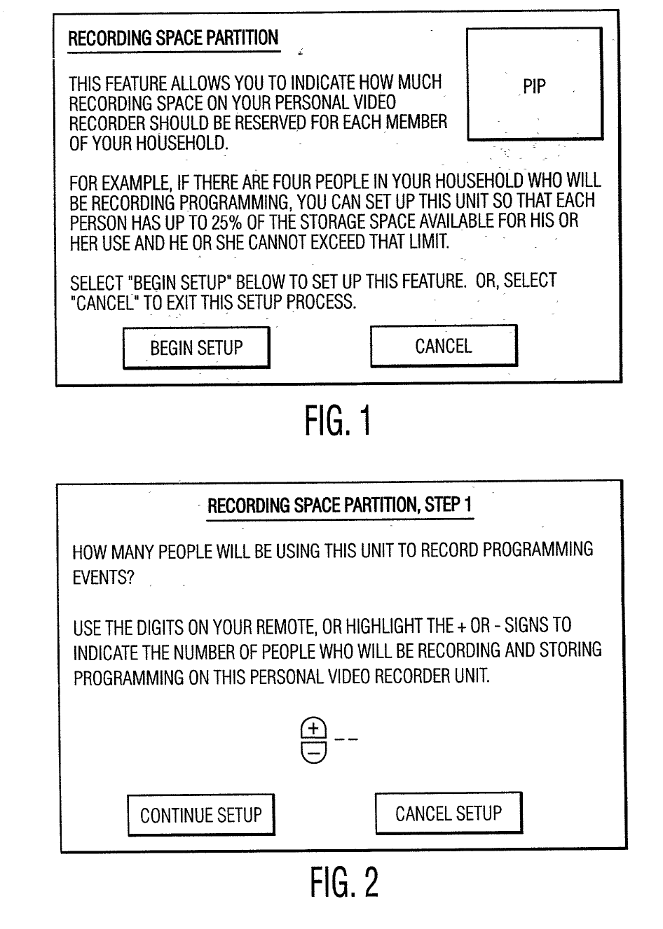

The method of the present invention will be described in relation to FIGS. 1-6, wherein FIGS. 1-6 are on-screen user interfaces 10, 20, 40, 60, 70 and 80 (hereinafter referred to as “OUIs”) to facilitate the user to carry out the method of the present invention. The user performing the “setup procedure” will hereinafter be referred to as “administrator” so as to eliminate any confusion with users who are allocated a partition of storage space.

Referring now to FIG. 1, the setup OUI 10 includes an on-screen display window 12 and a subwindow 18 for picture-and-picture display of a program. While the setup OUI 10 includes subwindow 18 for picture-and-picture display, such subwindow 18 is optional and may be omitted. The setup OUI 10 further includes a text-based message 14 describing in general the procedure to partition the recording space in the system's memory or storage medium 122 (FIG. 8). Additionally, two virtual buttons, “Begin Setup” button 16a and “Cancel” button 16b are provided. The “Cancel” button 16b cancels the procedure. The “Begin Setup” button 16a navigates the administrator to the next OUI, the partitioning OUI 20.

The setup OUI 10 is accessible by the administrator from a menu system (NOT SHOWN) of a PVR or DRV product (system 110) according to the principles of the present invention. It should be noted, the data entry described herein may be entered via the virtual buttons or data entry controls of the OUI's and, alternately, with the remote control (NOT SHOWN) used to make or enter selections via the menu system of the PVR or DRV product.

Referring now to FIG. 2, the partitioning OUI 20 allows the administrator to establish the number (N) of discrete partitions in the memory or storage medium 122. For example, the number (N) of discrete partitions may be a function of the number of users present in the household who will be recording programming. However, each discrete partition may be designated for more than a single user such that a discrete partition may be used by a group of users or common for the whole household. Accordingly, a user herein may be a single person or a group of persons.

The number (N) of discrete partitions to be created in the memory or storage medium 122 is entered by selecting virtual plus or minus icons 24a and 24b found within an on-screen display window 22 of FIG. 2. Selecting the virtual plus icon 24a increments the number found in number field 28. On the other hand, selecting the virtual minus icon 24b decrements the number found in the number field 28. As shown, the number field 28 includes two positions for two digits. Alternately, the administrator can also use the digit (numerical) keys on a remote control to enter the N.

In an exemplary embodiment of FIG. 2, N=4 indicates that the memory or storage medium 122 will be partitioned into four (4) discrete partitions. Therefore, four (4) users will be authorized to recording programming in their respective partitions, as will be described in detail below. The partitioning OUI 20 further includes virtual buttons “Continue Setup” button 26a and “Cancel Setup” button 26b. The “Cancel Setup” button 26b cancels the procedure. The “Continue Setup” button 26a navigates the administrator to the next OUI, partition naming OUI 40.

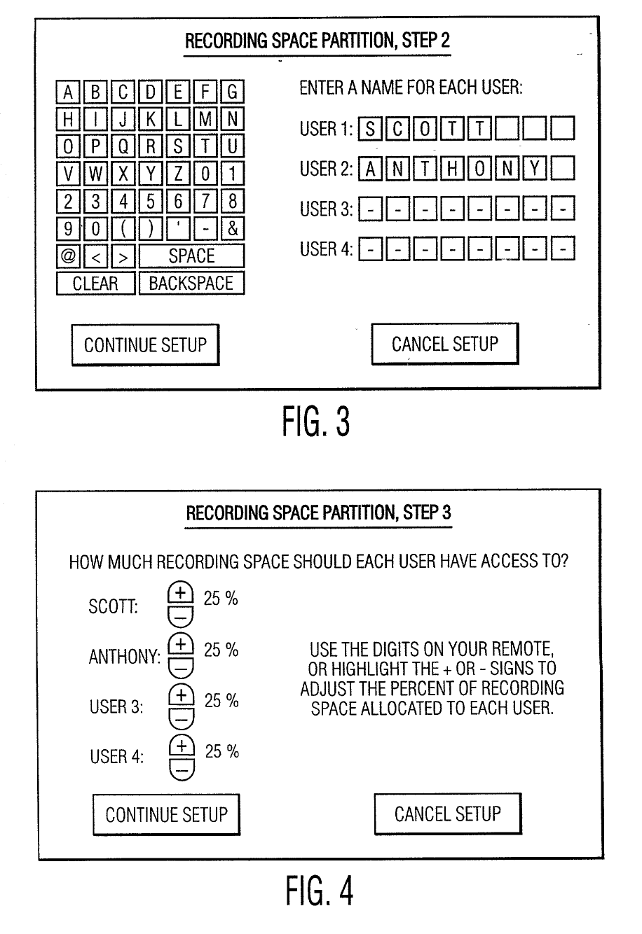

Referring now to FIG. 3, the partition naming OUI 40 allows the administrator to label, such as by using a user's name or other nomenclature, each discrete partition via N partition naming or labeling data entry fields 44₁, 44₂, . . . , 44_{N} within on-screen display window 42. The partition naming OUI 40 includes a virtual keypad 50 for entering alphanumeric characters for labeling or assigning a user name or other nomenclature to each discrete partition. Alternately, the administrator could also use a remote keyboard to enter the names or a remote control having an alphanumeric touch pad. In addition, prestored labels such as graphical icons may be associated for each user.

For example, if four (4) is the number of discrete partitions identified in the partitioning OUI 20, then four (4) labeling data entry fields 44₁, 44₂, . . . , 44_{N} are displayed for entering the names or labels of the partitions. Furthermore, during setup, the partition naming OUI 40 may provide default labels, such as “User 1”, “User 2”, “User 3”, and “User 4”, thus allowing the administrator to skip this step (the naming step) and speed up the process.

The virtual keypad 50 includes a set of alphabet keys 52, a set of numeric keys 54, a clear key 56, backspace key 58 and space key 59. The partition naming OUI 40 further includes two virtual buttons “Continue Setup” button 46a and “Cancel Setup” button 46b. The “Cancel Setup” button 46b cancels the procedure. The “Continue Setup” button 46a navigates the administrator to the next OUI, partition sizing OUI 60 (FIG. 4) where the administrator may be asked to allocate a percentage of the memory or storage medium 122 to each discrete partition.

With reference to FIG. 4, the system 110 may automatically assign a default percentage of the memory or storage medium 122 to each discrete partition. The default percentage allocated to each of the four (4) discrete partitions is evenly divided for a percentage of 25%. The percentage of the memory or storage medium 122 for each discrete partition is varied by selecting one of the N pairs of virtual plus or minus icons 64₁, 64₂, . . . 64_{N} found within the on-screen display window 62. Selecting the plus icon of pair 64₁ increments the percentage found in number field 68₁ for the “Scott” partition. On the other hand, selecting the minus icon of the pair 64₁ decrements the numbers found in the number field 68₁ for the “Scott” partition. As shown, the number field 68₁ includes two positions for two digits. Accordingly, the N pairs of virtual plus or minus icons 64₁, 64₂, . . . 64_{N} controls the percentage found in number field 68₁, 68₂, . . . 68_{N}, respectively. Moreover, the N pairs of virtual plus or minus icons 64₁, 64₂, . . . 64_{N} has a label or user name associated therewith wherein such label or name was entered in the partition naming OUI 40 (FIG. 3) or remained as the default label. Alternately, the administrator can also use the digits keys on a remote control to enter the percentage (%) value.

The partition sizing OUI 60 further includes two virtual buttons “Continue Setup” button 66a and “Cancel Setup” button 66b. The “Cancel Setup” button 66b cancels the procedure. The “Continue Setup” button 66a navigates the administrator to the next OUI, partition protection OUI 70 where the administrator can establish password protection for each discrete partition in the memory or storage medium 122.

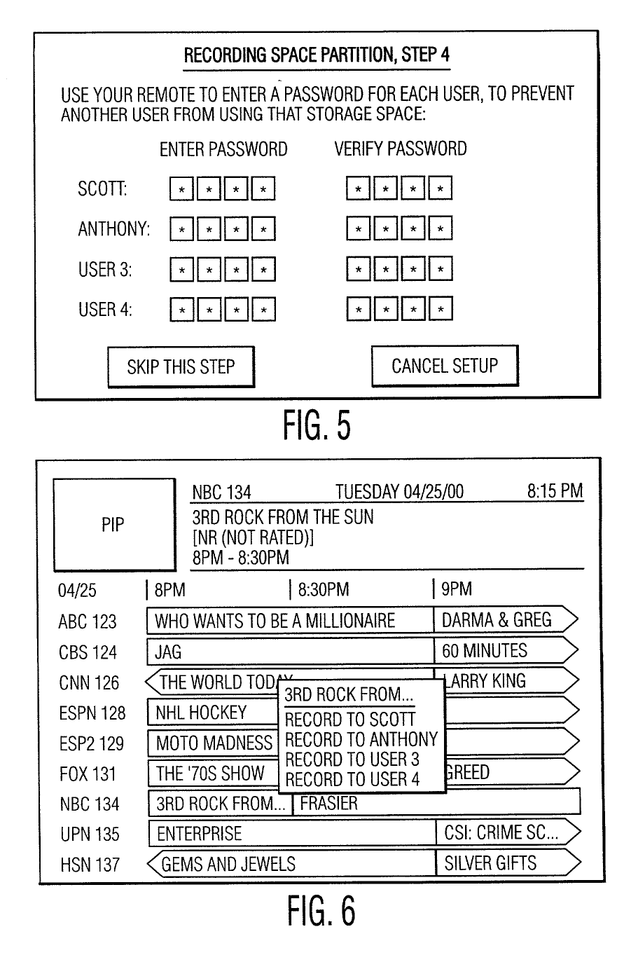

Referring now to FIG. 5, partition protection OUI 60 allows the administrator or each user to enter a personal password in the N password data entry fields 78₁, 78₂, . . . 78_{N}, designated for the N discrete partitions. Each of the N password data entry fields 78₁, 78₂, . . . 78_{N} has a label or user name associated therewith wherein such label or name was entered in the partition naming OUI 40 (FIG. 3). In operation, when a recording request is made, the password should be entered by an authorized user to prevent unauthorized users from accessing the partition of storage space allocated to another user. This would ensure that each user has access only to his or her allocated partition of storage space. During setup, the administrator can enter a password for each of the designated users, and then provide that such password to the appropriate user.

It should be noted that “accessing the partition of storage space” encompasses both recording (storing) in the partition of storage space and viewing recordings previously stored in the partition of storage space.

The N password data entry fields 78₁, 78₂, . . . 78_{N} has N password verify data entry fields 79i, 792, . . . ⁷⁹N, respectively, for re-entering the password to verify the password was entered correctly. The partition protection OUI 70 further includes virtual buttons “Continue Setup” button 76a and “Cancel Setup” button 76b. The “Cancel Setup” button 76b cancels the procedure. The “Continue Setup” button 76a allows the administrator to continue to the next OUI, the partition sharing OUI 80 in FIG. 6. In the exemplary embodiment, the N password data entry fields 78₁, 78₂, . . . 78_{N} do not have to be filled in to continue or, in other words, are not mandatory.

Thus, to skip the step where the passwords are entered, the administrator only need to select the “Continue Setup” button 76a to move to the next OUI, the partition sharing OUI 80.

In another aspect of the present invention, the system 110 may be implemented so that a user could only view programs that had been recorded to his or her allocated storage space. In another embodiment, the user is able to make a selection so that programs recorded on his or her allocation space may be shared or not shared by other users depending on a particular setting in, for example, the preference profile of each user.

Referring now to FIG. 6, the partition sharing OUI 80 is shown. The partition sharing OUI 80 includes a list 82 of the labeled N discrete partitions each of which is labeled with a users name, for example, “Scott,” “Anthony,” “User 3” and “User 4”. Each partition label has associated therewith a pair of buttons arranged in a Yes column 84a and a No column 84b. The administrator indicates with the Yes/No button selection whether or not the programs recorded to a particular partition allocated to a user should be shared with other users.

The partition sharing OUI 80 further includes two virtual buttons “Finish Setup” button 86a and “Cancel Setup” button 86b. The “Cancel Setup” button 86b cancels the procedure. The “Finish Setup” button 86a finishes the setup procedure for partitioning the memory or storage medium 122.

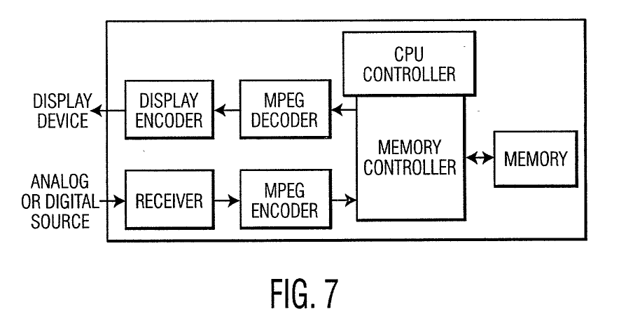

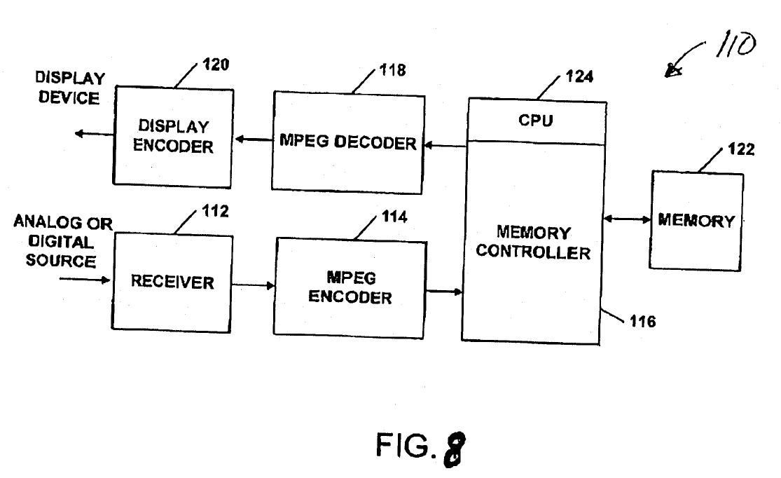

The recording operation of the system 110 of the present invention will now be described. With reference to FIG. 7, an electronic programming guide (EPG) 90 with an overlaid recording selection menu 94 is shown. The EPG 90 includes a time schedule row 96 that displays a time segment or window of 1.5 hours. In the exemplary embodiment, the time windows include an 8PM window, 8:30PM window and a 9PM window. The EPG 90 also includes a channel identifying column 98 that indicates in sequence the channel numbers and their respective channel name. The EPG 90 provides a plurality of title cells 100 wherein each cell has associated therewith a program name identifying a scheduled program mapped to a corresponding time, as indicated by the time schedule row 96, and to a corresponding channel, as indicated by the channel identifying column 98. Upon highlighting one of the title cells 100, program information 104 is displayed at the top of the display screen 92. The display screen 92 further includes a subwindow 108 for a picture-and-picture display.

In the exemplary embodiment, the title cell having the program name “3^{rd} Rock From . . . ” is highlighted. When the title cell is highlighted, the program information 104 associated with “3^{rd} Rock From . . . ” is displayed and includes, the channel name, channel number, date, time, etc. When the user selects to record the program of the highlighted title cell, the recording selection menu 94 is overlaid on the EPG 90 and displays a list 94a of the labeled or named discrete partitions. In the preferred embodiment, the recording selection menu 94 also displays the program name to be recorded.

To record, the user selects the highlighted program cell of the EPG 90. Thereafter, the recording selection menu 94 is overlaid on the EPG 90 and shows a primary highlight on “Record to Scott.” Highlighting one the cells of menu 94 identifies a partition name or label selected. Thus, the recorded program will be recorded in the storage of the selected partition.

As established in the setup procedure, the discrete partitions are named “Scott,” “Anthony,” “User 3” and “User 4.” Upon highlighting one of the discrete partitions listed in list 94a, the selected scheduled program to be recorded is recorded in the assigned or allotted partition selected from list 94a.

In the preferred embodiment, once the user selected a partition to record the program to, a password data entry screen or window (NOT SHOWN) may appear over the EPG 90 to allow the user to enter the password for the selected partition if one is required.

When the user decides to watch something that had been previously recorded, generally there is a PVR or DVR menu system that lists the recorded events. In the exemplary embodiment, before the PVR or DVR menu system of recorded programs is displayed, a list of the profiles/partitions would be displayed for selection by the user. If the administrator had indicated that the selected partition was not to share recorded events with other users, a password data entry screen or window would be presented to enter the password to a designated partition. Alternatively a user which has no set to be shared will not be displayed in an initial screen.

With reference now to FIG. 8, a general exemplary block diagram of the video recording system 110 for use in carrying out the present invention is shown. The video recording system 110 includes receiver 112 adapted to receive schedule programming information from an analog or digital source identifying the time and channel number of the scheduled programming. The receiver 112 is coupled to an MPEG encoder 114 for encoding the received signal output at receiver 112. The MPEG encoder 114 is couple to memory controller 116. The memory controller 116 is coupled to MPEG decoder 118. The MPEG decoder 118 is coupled to display encoder 120 which sends signals to a display device (NOT SHOWN), such as a television.

The on-screen user interfaces 10, 20, 40, 60, 70 and 80 (FIGS. 1-6) are created by system 110 and displayed on the display device. Furthermore, the system 110 includes CPU 124. The memory controller 116 is also coupled to memory or storage medium 122 for storing recorded schedule programming. The memory or storage medium 122 may be a hard disk drive or other memory medium. As is well known, the system 110 requires a certain amount of memory to process, format and function in the manner as described above. The memory or storage medium 122 includes in general two categories of memory, 1) for system operations and 2) dedicated program recording storage. It is the program recording storage that is partitioned and subdivided. Accordingly, one-hundred (100) percent of the program recording storage may be partitioned and subdivided.

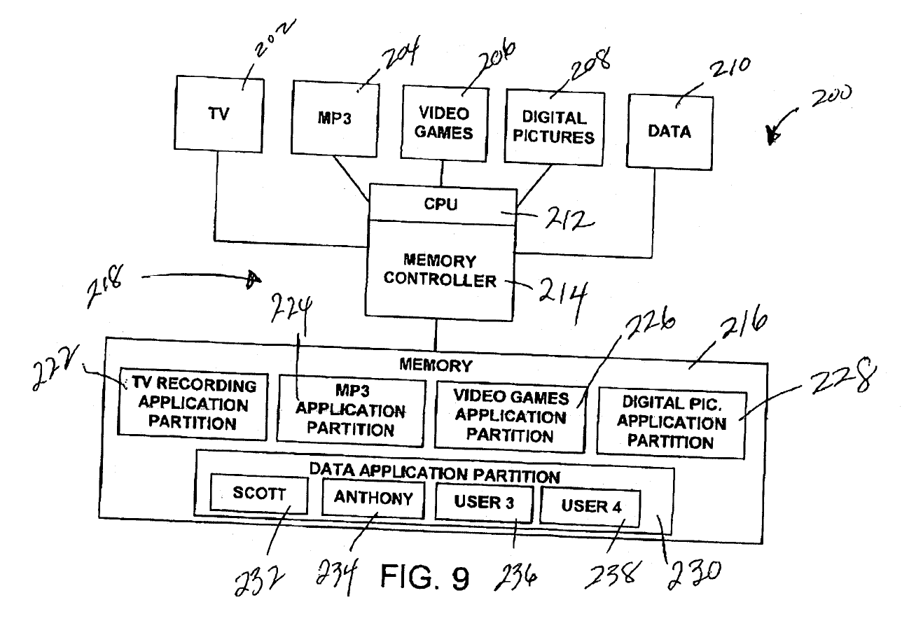

Referring now to FIG. 9, an exemplary multi-media system 200 of the present invention is shown. The multi-media system 200 supports a variety of applications/devices such as TV 202, MP3 music 204, video games 206, digital still pictures 208 and data 210. The multi-media system 200 has a central processing unit (CPU) 212, a partitionable hard drive memory 216 and memory controller 214. The CPU 202 operates in cooperation with the hard drive memory 216 to selectively perform various multi-media applications. The multi-media system 200 is designed to perform at least one multi-media application at a time. Accordingly, at least two multi-media applications may be in operation, simultaneously. The applications/devices such as television (TV) 202 with recording, MP3 music 204, video games 206, digital still pictures 208 and data 210 may be stand alone devices that reside in different location in a home or building or in the same room as an entertainment system. It should be noted that the multi-media system 200 may included a settop unit 218 that includes the CPU 212, the memory controller 214, the partitionable hard drive memory 216 and various ports, plugs or drives to connect to a cable or satellite television service, MP3 player, video game device, digital camera and/or digital memory card, video camcorder and computer.

To prevent one application/device and users from demanding or hogging the available capacity of the hard drive memory 216, the hard drive memory 216 is adapted to be divided into a plurality of dedicated application memory partitions 222, 224, 226, 228 and 230. However, the partitions 222, 224, 226, 228 and 230 can be reconfigured from time to time based on consumption and remaining memory of a particular application. In the exemplary embodiment, partition 222 is the TV recording application partition; partition 224 is the MP3 music application partition; partition 226 is the video games application partition; partition 228 is the digital picture application partition; and, partition 230 is the data application partition.

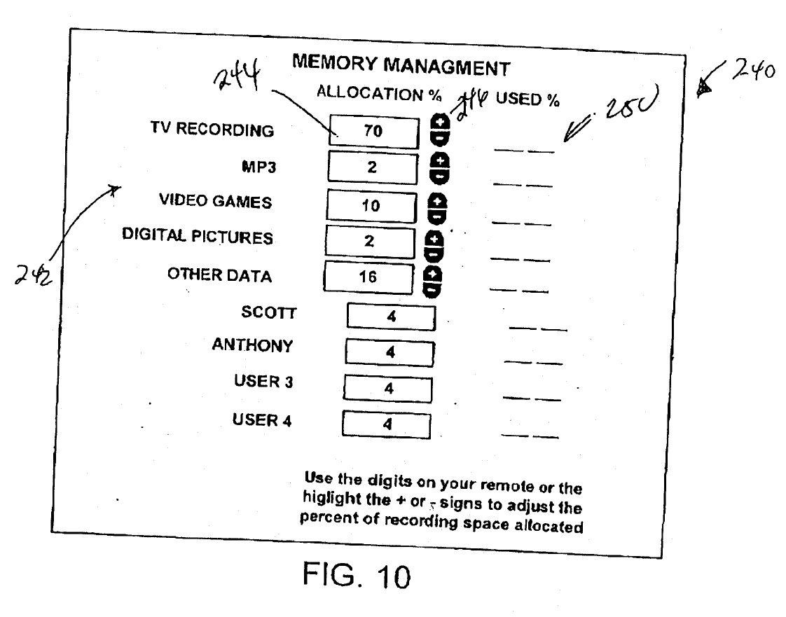

Referring also to FIG. 10, the memory management OUI 240 is shown. Since the memory 216 can be configured a variety of ways to describe each configuration is prohibitive. Thus, the description below is for exemplary purposes only. The partitionable hard drive memory 216 is, for example, 60 Gbytes. The dedicated application partitions are labeled by application in partition list 242. Each partition label has associated therewith a memory allocation data entry field 244 for entering a percentage of memory. Initially, the system 200 may automatically assign a default percentage to each dedicated application partition 222, 224, 226, 228 and 230.

The “Other Data” application partition 230 is subdivided into N subpartitions 232, 234, 236 and 238, such as for N users. In the exemplary embodiment, the default percentage of subpartitions 232, 234, 236 and 238 is four (4%) percent. As shown the “Other Data” application partition 230 has 16% allocated. The percentage of the application partition 230 can be varied by selecting one of the associated virtual plus or minus icons 246. Selecting the plus icon of the pair increments the percentage found in data entry field 244. On the other hand, selecting the minus icon of the pair 246 decrements the numbers found in the data entry field 244. Alternately, the administrator can also use the digits keys on a remote control to enter the percentage (%) value.

In the exemplary embodiment, the default percentage of subpartitions 232, 234, 236 and 238 is approximately 1/N of the default percentage of the “Other Data” application partition 230. Therefore, adjusting the percentage allocation of the “Other Data” application partition 230 adjusts the percentage of subpartitions.

Associated with each percentage allocation data entry field 244 in the allocation column, there is a used percentage column that identifies the amount of memory used in each dedicated application partition 222, 224, 226, 228 and 230 and subpartitions 232, 234, 236 and 238 As shown, the used field 250 has two positions for two digits.

In the exemplary embodiment, the memory 216 is partitioned as follows: 70% is dedicated to TV video recording application partition 222; 10% is dedicated to the video games application partition 226; 2% is dedicated to MP3 music application partition 224; 2% is dedicated to digital pictures application partition 228; and 16% is dedicated to “Other Data” application partition 230. In the “Other Data” application partition 230, the subpartitions are password protected and are labeled in accordance with the embodiment described above in relations to FIGS. 1-6. Accordingly, the “Scott” subpartition has 4% of memory; the “Anthony” subpartition has 4% of memory; the “User 3” subpartition has 4% memory; and the “User 4” subpartition has 4% of memory. In this embodiment, the subpartitions 232, 234, 236, 238 and 240 can be used to store music, still pictures, video games, data as well as recorded video in password protected memory space.

The partition protection OUI 60 (FIG. 5) can be used to password protect the subpartitions 232, 234, 236, 238 and 240 for privacy. Furthermore, the setup procedure described above in relation to FIGS. 1-6 can be used to establish the subpartitions.

The memory management OUI 240 in FIG. 10 displays how the memory is divided and utilized. The management of the memory partitions includes deleting the oldest recording to create memory space for the most recent recording. For other area such as MP3 music and still pictures, the memory management would allow manual deleting and archiving individual files to make room for higher priority information. The memory management functions to quickly modify the memory allocation when a new application or new user is added.

During setup, the administrator would be instructed as to how best partition the memory for each application. For example, typically, 10 times more memory is needed to record TV video since video fundamentally consumes more memory. Therefore, the multi-media system 200 would automatically allot a default amount of memory to each application partition.

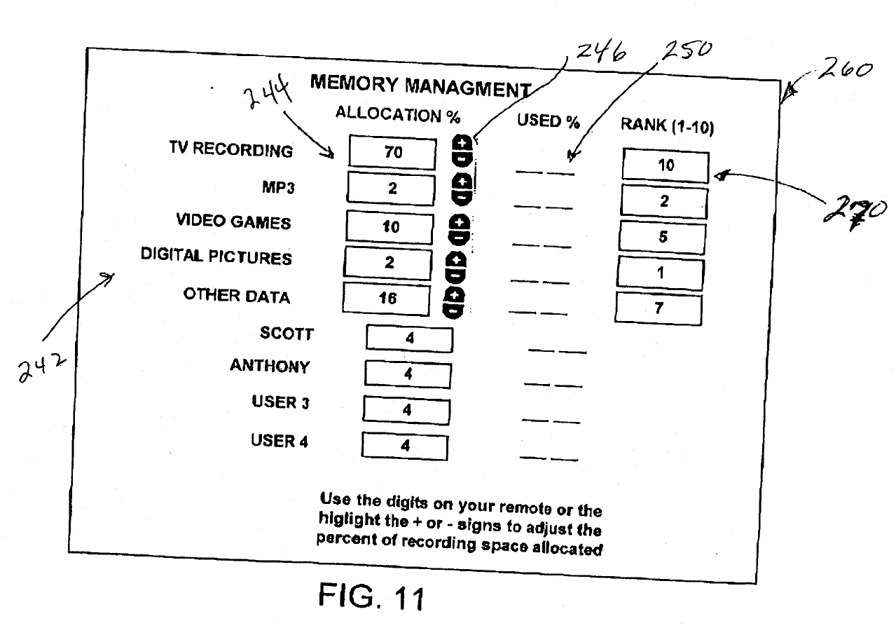

Referring now to FIG. 11, an alternate embodiment of the memory management OUI 260 is shown. Here, the user could rank the application in order of priority in rank data entry field 270. In the exemplary embodiment, the ranking range could be 1-10 where 10 is the most often used application and 1 being the least used application. Therefore, based on the ranking, the default memory allocation for a particular application partition could be increased for those ranked as higher priority and decreased for those ranked as lower priority.

In alternate embodiment, the multi-media system 200 monitors the activity or usage of the applications. Based on the monitored activity or usage, the multi-media system 200 gradually allots more memory to those application partitions that are used most often.

While the exemplary embodiment describes the devices comprised of a TV, a MP3 player, a video game device, etc., the invention is applicable to other devices which are networked. Accordingly, the networked devices would be connected to settop unit 218, where settop unit 218 manages the storage across multiple networked devices so that the overall storage capacity is shared. For example, the settop unit 218 may be integrated into or with a network server. Therefore, devices which are heavily used can be allotted more memory than devices which are used less.

Furthermore, each networked device may support multiple applications and the memory is partitioned by application.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications, which come within the scope of the appended claims, is reserved.

What is claimed is:

1. A video recording system comprising:
means for recording a video to a storage space; and
means for dividing the storage space into discrete partitions wherein each discrete partition is allocated to one of a plurality of users so that a respective user can record the selected video in their allocated discrete partition.

2. The system according to claim 1, further comprising means for password protecting the allocated discrete partition.

3. The system according to claim 1, further comprising:
means for entering information to label each discrete partition;
means for identifying an amount of storage space in each discrete partition; and
means for entering a password to protect said each discrete partition.

4. The system according to claim 3, wherein the label is a name of an authorized user.

5. The system according to claim 1, further comprising means for selecting a video for recording.

6. The system according to claim 5, further comprising:
means for displaying a list of the discrete partitions; and
means for selecting a discrete partition from the list to access the discrete partition.

7. The system according to claim 1, further comprising means for allocating an amount of storage space in said each discrete partition.

8. The system according to claim 7, wherein the system is one of a personal video recording system (PVR) and a digital recording system (DVR).

9. A method of recording video for a plurality of users comprising the steps of:
partitioning recording space in a recording storage medium into a plurality of discrete partitions;
allocating each respective discrete partition to a respective one of the plurality of users; and
recording a selected program in the respective discrete partition allocated to the respective user.

10. The method according to claim 9, further comprising the step of:
authorizing access to the respective discrete partition in response to a password entry.

11. The method according to claim 9, further comprising the steps of:
displaying a schedule of programming; and
selecting from the schedule of programming the selected program.

12. The method according to claim 9, wherein the partitioning step includes the steps of:
entering alphanumeric information to label each discrete partition; and
allocating an amount of recording space for each discrete partition.

13. The method according to claim 12, wherein the label is a user's name.

14. The method according to claim 9, wherein the partitioning step includes the steps of:
entering a number (N) of discrete partitions to be created; and
dividing the recording space in the recording storage medium between the N discrete partitions.

15. The method according to claim 9, wherein the partitioning step further comprises entering a password to protect each discrete partition from unauthorized recording.

16. The method according to claim 9, further comprising the steps of:
displaying a schedule of programs via an electronic programming guide, the electronic programming guide having program names;
selecting a program name from the electronic programming guide;
overlaying on the electronic programming guide, a list of discrete partition labels; and
selecting a discrete partition label from the list.

17. The method according to claim 16, further comprising the step of authorizing recording to the selected discrete partition label.

18. The method according to claim 17, wherein the step of authorizing access comprising the step of requesting a password.

19. The method according to claim 9, further comprising the step of:
identifying those partitions which are to be shared.

20. A method for recording multi-media information from a plurality of multi-media applications in an entertainment device, comprising the steps of:
partitioning memory into a plurality of application partitions based on the type of multi-media applications and;
allocating an amount of memory to each partition of the plurality of application partitions according to their application type.

21. The method according to claim 20, further comprising the steps of:
ranking each application; and
modifying the amount of memory in said each partition based on the ranking of the associated application.

22. The method according to claim 20, further including the step of managing the memory of each partition.

23. The method according to claim 20, wherein the managing step comprises the step of deleting oldest event to accommodate a new event.

24. The method according to claim 20, wherein the application type comprise at least one of the following: television recording, MP3 music, video games, digital pictures and data.

25. The method according to claim 20, further comprising the steps of:
subpartitioning one of the partitions of the plurality of dedicated application partitions into subpartitions; and
allocating each subpartition to a respective user.

26. The method according to claim 25, further comprising the steps of:
entering a user password for a selected respective user; and
authorizing access to the selected respective subpartition in response to the password being entered.

27. The method according to claim 26, further comprising the steps of:
selecting a program; and
recording the selected program in the respective subpartition allocated to the respective user.

28. The method according to claim 27, further comprising the steps of:
displaying a schedule of programming; and
selecting from the schedule of programming the selected program.

29. The method according to claim 25, wherein the subpartitioning step comprising the steps of:
entering alphanumeric information to label each subpartition; and
allocating an amount of recording space for each subpartition.

30. The method according to claim 25, wherein the subpartitioning step comprising the steps of:
entering a number (N) of subpartitions to be created; and
dividing the recording space in the partition between the N subpartitions.

31. The method according to claim 30, wherein the subpartitioning step further comprises entering a password to protect each subpartition from unauthorized use.

32. The method according to claim 25, further comprising the steps of:
selecting a multi-media application; and
recording the multi-media information of the selected multi-media application in the respective subpartition allocated to the respective user.

33. The method according to claim 32, wherein the application type comprise at least one of the following: television recording, MP3 music, video games, digital pictures and user data.

34. The method according to claim 32, wherein the plurality of multi-media applications is incorporated into a networked device wherein the networked device is one of a plurality of networked devices.

35. A method of managing storage capacity for a plurality of networked devices, comprising the steps of:
partitioning memory into a plurality of dedicated device partitions;
allocating an amount of memory to each partition of the plurality of dedicated device partitions; and
managing the memory of said each partition.

36. The method according to claim 35, further comprising the steps of:
ranking each networked device; and
modifying the amount of memory in said each partition based on the ranking of the networked device.

37. The method according to claim 35, further comprising the steps of:
subpartitioning one of the partitions of the plurality of dedicated device partitions into subpartitions; and
allocating each subpartition to a respective user.

38. The method according to claim 37, further comprising the steps of:
the respective user entering a user password; and
authorizing access to the respective subpartition in response to the password being entered.
